(19) United States
(12) Patent Application Publication
(10) Pub. No.: US 2026/0250586 A1
(43) Pub. Date: Aug. 27, 2026

(54) Ultra-Low Emission System for Conversion of Municipal Solid Waste and Biomass to Renewable Electrical Power and Sustainable Liquid Fuels

(71) Applicants: Barry Liss, Pompano Beach, FL (US); Bary W Wilson, Coconut Creek, FL (US)

(72) Inventors: Barry Liss, Pompano Beach, FL (US); Bary W Wilson, Coconut Creek, FL (US)

(21) Appl. No.: 19/546,859

(22) Filed: Feb. 23, 2026

Related U.S. Application Data
(60) Provisional application No. 63/761,552, filed on Feb. 21, 2025.
(60) Provisional application No. 63/775,268, filed on Mar. 20, 2025.

(51) Int. Cl. C10J 3/00; B01D 53/14

(52) U.S. Cl. CPC C10J 3/005; B01D 53/1475; B01D 2252/204; B01D 2257/504; C10J 2300/0906; C10J 2300/0909; C10J 2300/092; C10J 2300/0946; C10J 2300/1671; C10J 2300/1684

(57) ABSTRACT

The present technology integrates multiple technologies to substantially reduce the economic and environmental cost of managing municipal solid waste (MSW) and the biomass growth in forests or rangelands. The technology employs rotary kiln gasification of MSW to generate steam, renewable electrical energy, and an inorganic sintered ash suitable for a variety of uses. Net electrical power from the power plant is used to operate a pyrolysis system or a hydrothermal liquefaction unit that converts wood biomass to liquid hydrocarbon fuels. A carbon capture and utilization system uses CO₂ recovered from the power plant exhaust stack to generate a variety of fuels and/or specialty chemicals. Steam from the power plant is used to make activated carbon from the char residue from pyrolysis. Revenue from the technology includes gate fees for MSW diverted from landfill, renewable electrical power to the grid, a variety of liquid hydrocarbon fuels and activated carbon.

### CROSS-REFERENCE TO RELATED APPLICATIONS

This application claims priority to U.S. Provisional Patent Application No. 63/775,268, filed on Mar. 20, 2025, and U.S. Provisional Patent Application No. 63/761,552, filed on Feb. 21, 2025, the entire contents of which are incorporated herein by reference.

### FIELD OF THE TECHNOLOGY

The present technology relates to a method for reducing multiple sources of greenhouse and hazardous air pollutant gas emissions by employing gasification to generate renewable power. More particularly, reducing multiple sources of greenhouse and hazardous air pollutant gas emissions by gasifying municipal solid waste (MSW) diverted from landfills and wood biomass obtained from forestry operations. Furthermore, the present technology employs the renewable power to convert wood biomass and selected plastics into sustainable liquid fuels using pyrolysis or hydrothermal liquefaction (HTL). Still further, the present technology produces activated carbon by steam or other reagent treatment of the pyrolysis char. Still further, the present technology reduces carbon emissions by converting carbon dioxide captured from the power plant exhaust gas to a methane rich gas, liquid fuel, or specialty chemicals.

### BACKGROUND OF THE TECHNOLOGY

Carbon dioxide (CO₂) is a significant contributor to increased greenhouse gas equivalent (GHGe) emissions leading to global warming and resultant climate change. As a group, the transportation, electrical power generation, and industrial sectors of the US economy account for approximately 76% of US GHGe emissions. Landfills account for another 8% of US GHGe emissions. The estimated economic costs associated with incremental increases in CO₂ emissions are approximately $50 per metric ton of CO₂. More than 6,000 million metric tons of anthropogenic CO₂ were emitted in the US during 2022, putting the total economic cost in the range of $300 billion annually.

In order to mitigate GHGe emissions, the US Department of Energy (DOE) emphasizes deploying low carbon intensity technologies as well as carbon capture and storage technologies. Of more significance in reaching the US Government goal of net-zero carbon emissions by 2050 is the development and use of technologies that convert CO₂ to liquid fuels, specialty chemicals, or other beneficial and sustainable products. Carbon capture and storage technologies or utilization also provide a process to simultaneously reduce hazardous air pollutant (HAP) emissions.

The closure of markets for recyclable materials in the Far East, especially China, has resulted in more municipal solid waste (MSW) being placed in US landfills. Eastern US States including New York, New Jersey and Connecticut, for example, are rapidly running out of landfill airspace. The net annual landfill airspace loss in some regions of the US amounts to 30% of capacity over five years. The problem in the Northeastern US is exacerbated by the refusal of other states, formerly willing to accept MSW into landfills as a source of revenue, to continue accepting out-of-state waste. The shortage of landfill space is expected to increase disposal costs and to create a significant challenge for waste management. This trend is accelerating with the emerging recognition that per-and polyfluoroalkyl substances (PFAS) are hazardous chemicals found in MSW.

PFAS, also known as “forever chemicals,” are not readily broken down in the environment nor metabolized in plants and animals, thereby tending to accumulate in both. Several PFAS species are known to be toxic to plants and animals. PFAS are found in many consumer products, including carpeting, fire retardants, and water-resistant clothing. PFAS placed in landfills can enter the leachate over time. Leachate water collects in landfills and is pumped out and treated before release. However, PFAS are not removed by conventional leachate water treatment systems and thus may migrate into the environment, entering drinking water, irrigation water, and the like. PFAS may enter the food chain via plants and animals that ingest PFAS contaminated water and agricultural products. Recent epidemiological studies indicate that certain PFAS can pose significant health risks to humans, including increased rates of cancer, liver damage, and compromised immune function. In addition to these adverse health effects, certain PFAS have demonstrated genotoxicity in plants and animals.

PFAS can be thermally dissociated at elevated temperatures and residence times provided by waste incinerators. Unfortunately, many conventional waste incinerators are nearing the end of their service life and are being decommissioned. These incinerators can release harmful pollutants, including dioxins, furans, and particulate matter, which can have serious adverse health and environmental impacts. The inefficiency of these incinerators in managing pollutant emissions has contributed to decisions to shut them down. It is unlikely that new MSW incinerators will be commissioned in many jurisdictions. As a result, there is a growing need for alternative waste management solutions that are sustainable and more environmentally friendly than current waste management systems. The present technology addresses the above-described issues and highlights a need for innovative and sustainable waste management practices that address the challenges posed by decreasing landfill capacity, PFAS contamination, and air emissions from landfills and waste incinerators.

Still further, demand reductions for some traditional paper products coupled with increased energy and labor costs are making many traditional pulp and paper mills unprofitable. For example, reduced local demand for pulp wood in the eastern US has caused a downturn in harvested biomass from managed regional forests. In turn, a lack of programmed harvesting and selective biomass growth removal has resulted in less healthy and productive forests, which has increased forest fire risk.

To exacerbate the issue, climate change has increased the frequency and severity of wildfires in forests and rangelands, especially in the Southwestern US, with brief periods of increased precipitation followed by extended drought. Wildfires destroy natural habitats and property, while releasing significant GHGe and particulate matter into the atmosphere that further contributes to climate change.

Thinning tree density and brush can help reduce fire risk and can help improve forest and rangeland health. Mechanical thinning of unwanted biomass, especially when small trees and brush are involved, conventionally results in slash piles that are often burned in the open. The issue of the stranded managed forest biomass resources may be addressed by providing an environmentally responsible and economically attractive method of converting the biomass into sustainable biofuels and activated carbon. The present technology addresses greenhouse gas emission reductions in the transportation sector by making renewable liquid fuels. Furthermore, the present technology addresses greenhouse gas emission reductions in the electrical energy generation and industrial sectors by reducing GHGe emission, converting carbon dioxide into sustainable hydrocarbon fuels, and by thermally destroying toxic per fluoroalkanes (PFAS forever chemicals), which could otherwise be emitted from landfills.

### SUMMARY OF THE TECHNOLOGY

The present technology thermally converts refuse derived fuel (RDF) obtained from MSW to generate renewable power and steam. In addition to safely disposing MSW, the present technology uses woody biomass, especially from managed forests, as a feedstock for a pyrolysis process to liquids or a hydrothermal liquefaction process. Either one of these processes can convert biomass to liquid fuels. Furthermore, any plastic separated from the MSW feedstock can be a hydrogen rich feedstock for hydrothermal liquefaction or pyrolysis to produce renewable liquid fuels.

Integrated technologies described herein also may include carbon capture to remove CO₂ and HAPs from the power plant exhaust gas. The recovered CO₂ is used to make renewable hydrocarbon and oxygenated hydrocarbon fuels or to produce activated carbon from wood char. Alternatively, steam from the power plant heat recovery steam boiler or water gas generated in more than one point of the overall process can be used to treat wood char from the pyrolysis unit to make valuable activated carbon. These integrated technologies can provide a total reduction of 60% to 90% or more in the CO₂ emissions from the power plants compared to conventional techniques of producing energy from fossil fuels and conventional abatement of GHGe emissions for fossil energy exhaust stacks. Landfilling MSW results in synthesis and release of several GHG, most concerning of which is methane, which is approximately 24-fold more potent as a greenhouse gas than CO₂. In addition, HAP's also are reduced significantly over conventional air emissions control techniques.

According to one example, the technology described herein may employ the following independent systems: (1) a rotary kiln gasification steam power plant operating with flue gas recycle incorporating a multi-port feedstock inlet system using RDF sorted from MSW as the primary feedstock; (2) a pyrolysis system that converts feedstocks including, coal, woody biomass, plastic polymers, and waste tire crumb rubber, to liquid hydrocarbon fuels; (3) hydrothermal liquefaction, as an alternative to, or in concert with pyrolysis, to clean wood biomass and waste plastic to liquid or gas phase fuels; (4) a carbon capture and utilization (CC&U) system to extract CO₂ from the gasification train's flue gas, the CO₂ is converted to a methane rich fuel gas using catalytic ultrasonic cavitation, after which methanol or dimethyl ether fuel, and/or middle distillates rich in aviation and diesel fuel constituents, and/or specialty chemicals, are synthesized and (5) a steam or other reagent treatment unit that converts the residual pyrolysis char to activated carbon.

According to the present technology, these five independent systems can be integrated to operate as a functionally interdependent facility. Carbon capture reduces the GHGe and HAP (including criteria pollutant) emissions of the integrated facility and can increase the liquid fuel production. According to one example, the present technology may employ an air fed counter current rotary kiln gasification system that may be deployed with carbon capture. The facility described herein, with or without carbon capture, has economic and environmental advantages over presently deployed technologies for waste management. It addresses the need for reduced fossil carbon and criteria pollutant emissions, improved solid waste management, and production of sustainable liquid fuels.

### BRIEF DESCRIPTION OF THE FIGURES

FIG. 1 illustrates an interdependent facility that includes a rotary kiln gasification system, a pyrolysis system, hydrothermal liquefaction, a carbon capture and utilization (CC&U) system, and a steam or other reagent treatment unit according to one example of the technology;

FIG. 2 illustrates additional details of the system illustrated in FIG. 1 according to one example of the technology;

FIG. 3 illustrates a plasma assisted pyrolysis system according to one example of the technology;

FIG. 4 illustrates a carbon capture and utilization (CC&U) system according to one example of the technology;

FIG. 5 illustrates a rotary kiln gasification system according to one example of the technology;

FIG. 6 illustrates an overall system that receives and directs sorted MSW and biomass through different systems to produce various products according to one example of the technology;

FIG. 7A illustrates a plan view of a multi-port rotary kiln according to one example of the technology; and

FIG. 7B illustrates end view and side view elevations of the multi-port rotary kiln according to one example of the technology.

### DETAILED DESCRIPTION OF THE TECHNOLOGY

It will be readily understood by persons skilled in the art that the present disclosure has broad utility and application. In addition to the specific examples described herein, one of ordinary skill in the art will appreciate that this disclosure supports various adaptations, variations, modifications, and equivalent arrangements.

It will be appreciated that for simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, methods, procedures, and components are not described in detail so as not to obscure the related relevant feature being described. Also, the description is not to be considered as limiting the scope of the examples described herein. The drawings are not necessarily drawn to scale, and the proportions of certain parts may be exaggerated to better illustrate details and features of the present disclosure. Those skilled in the art with access to the teachings provided herein will recognize additional modifications, applications, and examples within the scope thereof and additional fields in which the technology would be of significant utility.

Unless defined otherwise, technical terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity but rather denote the presence of at least one of the referenced items. The term “or” is meant to be inclusive and means either, any, several, or all of the listed items. The terms “comprising,” “including,” and “having” are used interchangeably in this disclosure. The terms “comprising,” “including,” and “having” mean to include, but are not necessarily limited to the things so described. The terms “connected” and “coupled” can be such that the objects are permanently connected or releasably connected. The term “substantially” is defined to be essentially conforming to the thing that it “substantially” modifies, such that the thing need not be exact. For example, substantially 2 inches (2″) means that the dimension may include a slight variation.

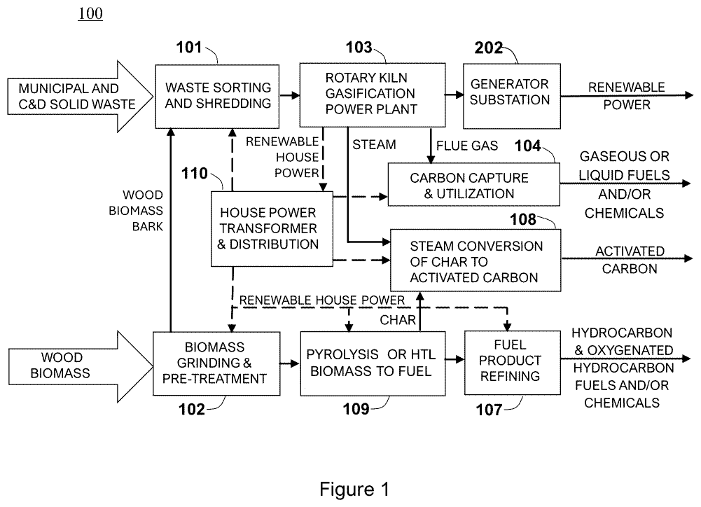

FIG. 1 illustrates an interdependent facility 100 that includes a rotary kiln gasification system, a pyrolysis system, hydrothermal liquefaction, a carbon capture and utilization (CC&U) system, and a steam or other reagent treatment unit according to one example of the technology. According to one example, the gasification power plant includes a waste sorting and shredding unit 101, a biomass grinding and pre-treatment system 102, and a rotary kiln gasification power plant 103. According to one example, the gasification power plant may be mechanically coupled to a pyrolysis or hydrothermal liquefaction plant (HTL) biomass to fuel plant 109 that converts wood biomass to liquid fuels. According to one example, the pyrolysis or HTL biomass to fuel plant 109 may be mechanically coupled to a fuel product refining unit 107 that provides filtration, distillation, while allowing additives and blending. According to one example, the interdependent facility 100 may include a steam conversion of char to activated carbon unit 108 that converts the char from the pyrolysis system. According to one example, the interdependent facility 100 may further include a carbon capture and utilization unit 104 that removes carbon dioxide from the power plant flue gas for ultrasonic cavitation assisted conversion to oxygenated hydrocarbon fuel preferably, a methane rich gas, methanol or dimethyl ether (DME). One of ordinary skill in the art will readily appreciate advantages of ultrasonic cavitation as described in WO 2025/077106 filed on Mar. 21, 2024, entitled “Temperature-enhanced Differential Multi-focal Ultrasonic Cavitation Apparatus,” the entire content of which is incorporated by reference herein. According to one example, electrical power from the gasification power plant may be distributed to the grid by a generator substation 202. Alternatively, in-house loads may be distributed by transformers and switchgear 110.

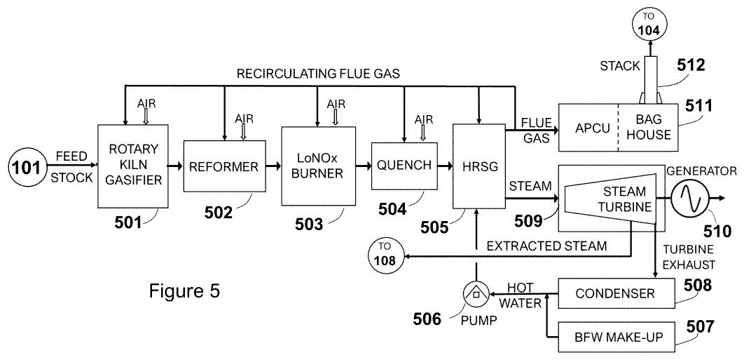

According to one example, FIG. 1 illustrates MSW delivered to the waste sorting and shredding facility 101 where it is reduced to a particle size of 200 mm or less to form RDF. According to one example, the RDF is inserted into one or more rotary kilns within the gasification power plant 103. According to one example, electricity produced from the rotary kilns within the gasification power plant 103 may be sent to a generator substation 202 for delivery or sale to the grid, as illustrated in more detail in FIG. 5. According to one example, the electrical power also may be sent to the in-house transformer and distribution center 110, where the electrical power is distributed to power in-house equipment including the biomass grinding and pre-treatment system 102, the carbon capture and utilization system 104 in which catalytic ultrasonic cavitation is used to convert CO₂ to methane using electrolytic hydrogen as required. FIG. 1 further illustrates units for conversion of wood or plastic feedstock to fuel using the Pyrolysis or HTL Biomass to Fuel unit 109, the fuel product refining unit 107, and the steam conversion of char to activated carbon unit 108.

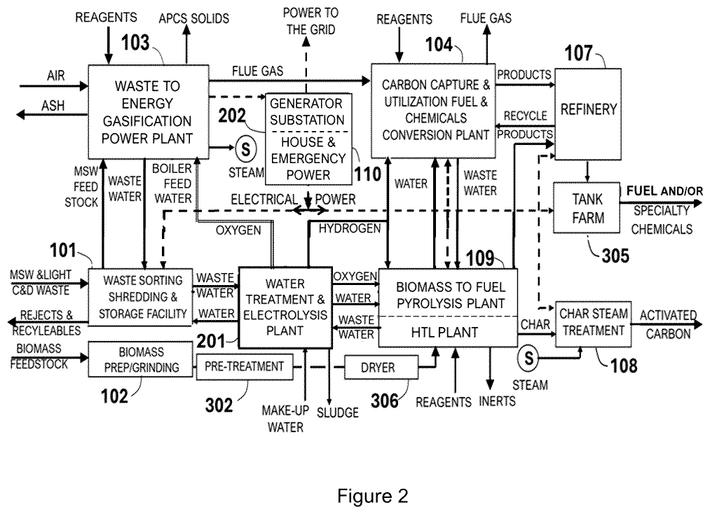

FIG. 1 further illustrates an example of systems for converting wood biomass to fuel. According to one example, clean, chipped and preferably sustainably harvested, wood biomass is delivered to the feedstock prep unit or waste sorting and shredding unit 101, where the chips are further reduced to a particle size of 5 mm or less by grinding. With reference to FIG. 2, the wood biomass feedstock is fed into a pre-treatment unit 302 and the pyrolysis or HTL Biomass to Fuel unit 109. According to one example, pyrolysis may include conventional thermal pyrolysis or plasma assisted pyrolysis. According to one example, plasma assisted pyrolysis may employ a low voltage high current plasma established between the auger blades or flights and the auger wall. According to one example, the plasma may electrochemically promote thermal decomposition of the lignin, cellulose, and hemicellulose components of the wood to form pyrolysis oils, syngas and non-condensable hydrocarbons, which may be refined by distillation in the refinery 107.

FIG. 2 illustrates additional details of the system illustrated in FIG. 1 according to one example of the technology. FIG. 2 illustrates a water treatment and electrolysis plant 201 that produces demineralized boiler feed water for electrolytic generation of hydrogen and oxygen that is employed to treat wastewater. FIG. 2 further illustrates a tank farm 305 for liquid product storage. According to one example, the generator substation 202 provides renewable electricity to the power grid and is configured to provide power to the facility, if needed. According to one example, the house power transformer 110 may provide power to all or some electrical devices within the interdependent facility 100. According to one example, electricity from an emergency generator in the house and emergency power unit 110 also can be used for black start of the gasification power plant. According to one example, a biomass pre-treatment unit 302 and a dryer 306 may be employed prior to delivering biomass to the pyrolysis or HTL Biomass to Fuel unit 109.

According to one example, FIG. 2 illustrates one example of how the water treatment and electrolysis plant 201 and the distribution system are integrated with the components illustrated in FIG. 1. According to one example, the water treatment and electrolysis plant 201 provides water for the various process units, including the demineralized boiler feed water unit 507 illustrated in FIG. 5 that is provided within the gasification power plant. According to one example, water is employed for electrolysis to produce hydrogen and oxygen that is provided to the pyrolysis or HTL Biomass to Fuel unit 109. According to one example, the pyrolysis or HTL Biomass to Fuel unit 109, which converts woody biomass to pyrolysis oil and syngas, also can be used to convert other monofuel feedstocks, including coal and crumb rubber from waste tires. According to one example, feedstock for the pyrolysis or HTL Biomass to Fuel unit 109 must be ground to a particle size of 5 mm or less depending on its composition.

FIG. 2 illustrates further detail of the biomass conversion process by pyrolysis or HTL processing, including a biomass grinding and pre-treatment system 102 for grinding wood biomass to a particle size of less than 5 mm, a pre-treatment unit 302 of the biomass feedstock, a dryer 306 for the pretreated biomass and insertion of the pretreated biomass feedstock into the pyrolysis or HTL Biomass to Fuel unit 109. According to one example, the char from pyrolysis of the wood biomass is further treated with steam by the Char Steam Treatment unit 108 to produce activated carbon.

According to one example, liquid fuel produced in the pyrolysis or HTL Biomass to Fuel unit 109 and the carbon capture and utilization fuel and chemicals conversion plant 104 is further refined in the refinery 107 by filtration. distillation, hydrotreating or other methods and stored in tanks provided in a tank farm 305 for sale and shipment.

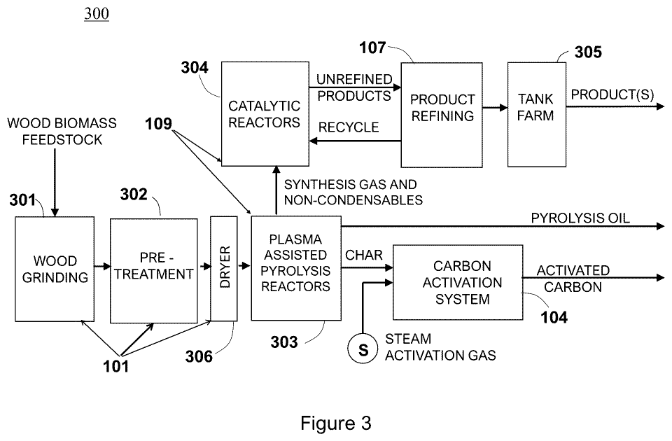

FIG. 3 illustrates a plasma assisted pyrolysis system for the interdependent facility 100 according to one example of the technology. According to one example, the pyrolysis system includes a wood grinder 301, a pre-treatment tank 302, dryer units 306. According to one example, the waste sorting, shredding, and storage facility 101 may supply fuel to the biomass or wood grinder 301, the pre-treatment tank 302, and the feedstock dryer 306. According to one example, a plasma assisted pyrolysis reactor 303 may receive product from the dryer units 306 and may provide synthesis gas and non-condensable to a catalytic reactor 304. According to one example, the pyrolysis or HTL Biomass to Fuel unit 109 may provide product to the plasma assisted pyrolysis reactor 303 and/or the catalytic reactors 304. According to one example, any unrefined fuel product may be provided to the product refining unit 107 and any refined product may be stored in a tank farm 305. According to one example, the rotary kiln unit 103 may employ steam or other reagents to activate char that is provided to a carbon activation system 104 to produce activated carbon. According to one example, the carbon activation system 104 may receive steam from the rotary kiln unit 103, along with water gas from the pyrolysis or HTL Biomass to Fuel unit 109 or the rotary kiln unit 103.

FIG. 3 illustrates a block diagram of the pyrolysis or HTL Biomass to Fuel unit 109 providing product to the plasma assisted pyrolysis reactor 303 and/or the catalytic reactors 304. According to one example, the waste sorting, shredding, and storage facility 101 may supply product to the biomass or wood grinder 301, the pre-treatment tank 302, and the feedstock dryer 306. According to one example, an advanced plasma assisted pyrolysis reactor 303 may include an auger provided inside a tubular casing with a low-voltage, high-ampere electrical field imposed between the auger flights and the insulated inner wall of the auger housing. According to one example, this design may create a gliding arc type plasma between the tips of the auger flights and the outer casing wall. According to one example, the combined joule heating and plasma electric field effect may create localized high temperatures within the waste that leads to decomposition of the wood cellulose, hemi cellulose, and lignin components. According to one example, the plasma assisted pyrolysis system may dynamically adjust energy delivery to maintain optimal reactor temperatures and residence times. Furthermore, the plasma assisted pyrolysis system may be configured to adapt to specific characteristics of a waste stream. According to one example, the plasma assisted pyrolysis system may provide unrefined pyrolysis oil. According to one example, this liquid phase can be further refined through filtration and distillation to form middle distillate fuel products, including sustainable aviation turbine fuel (SAF) and diesel oil, or the like.

According to one example, the pyrolysis or HTL Biomass to Fuel unit 109 may include the wood grinder 301, the pre-treatment tank 302, the plasma assisted pyrolysis reactor 303, the catalytic reactors 304, and the feedstock dryer 306. According to one example, the pyrolysis or HTL Biomass to Fuel unit 109 may be a commercially available component. According to one example, the pyrolysis or HTL Biomass to Fuel unit 109 may convert harvested biomass to a marketable product using electricity from the gasification power plant. Furthermore, the technology may employ filtration and distillation capabilities of the refinery, blending, and storage units of the interdependent facility 100. According to one example, the pyrolysis technology described herein may produce a slate of products including pyrolysis oil, charcoal, activated carbon, methane rich gas, methanol, dimethyl ether, sustainable aviation fuel, renewable diesel, wood vinegar, pyroligneous acid, and refined chemicals, among other products.

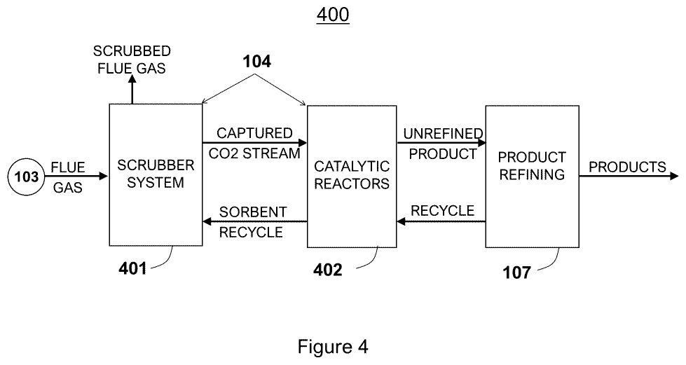

FIG. 4 illustrates a carbon capture and utilization (CC&U) system according to one example of the technology. According to one example, the CC&U system includes a scrubber 401, catalytic reactors 402, and a fuel product refinery 107. According to one example, carbon dioxide that enters the scrubber unit 401 is preferentially dissolved in an aqueous amine solution that is sent to plasma and phonon assisted catalytic reactors 402 for conversion to a variety of sustainable fuels and chemicals. According to one example, the raw fuel products are sent to the refinery 107 for final distillation or recycle. According to one example, the products available from the CC&U system include methane rich gas, methanol, dimethyl ether, SAF, renewable diesel, and specialty chemicals, among other products.

FIG. 5 illustrates a rotary kiln gasification system according to one example of the technology. According to one example, the rotary kiln gasification power plant 103 may include a LoNOx air fed rotary kiln gasification power plant. According to one example, the rotary kiln gasification power plant 103 may include a rotary kiln gasifier 501, a fuel gas reformer 502, a LoNOx burner 503, a quench system 504, and a boiler 505 designated as a heat recovery steam generator (HRSG). According to one example, the rotary kiln gasifier 501 may receive prepared combustible carbonaceous feedstock from feedstock prep unit 103. Specifically, MSW may be delivered the rotary kiln gasifier 501 via the feedstock prep unit 101. According to one example, MSW may be inspected prior to delivery to remove inert or hazardous waste materials. According to one example, the resulting MSW material may be mechanically shredded to a size of 200 mm or less before being fed to the rotary kiln gasifier 501 via an auger or ram feeder. According to one example, the quench system 504 may reduce the temperature of gas entering the boiler 505.

According to one example, steam extracted from a turbine 509 may be directed to a condenser 508. Furthermore, boiler feed make-up water 507 obtained from a water treatment plant 201 may be added into the turbine exhaust condensate circuit via the HRSG 505. According to one example, lower pressure steam extracted from the steam turbine 509 may be directed to a deaerator (not shown), a boiler feedwater preheater, and/or the steam conversion of char to activated carbon unit 108. According to one example, steam turbine exhaust gas may be sent to a condenser 508 and the deaerator, where the steam is condensed to a liquid and the gas is removed to again enter the steam Rankine cycle. According to one example, hot water obtained from the condenser 508 and/or the boiler feed make-up water 507 may be pressurized to high pressure by a pump 506 before being provided to the HRSG 505. According to one example, the pump 506 may be a positive displacement pump 506. Details of a conventional Rankine cycle are known to those of ordinary skill in the art and are not described herein.

According to one example, steam from the HRSG 505 may power an extraction steam turbine 509 that drives an electrical generator 510. According to one example, power from the generator 510 may be directed to a transformer 110 that provides house power. Additionally, or alternatively, power from the generator 510 may be directed to a substation (202) that provides three-phase power at transmission line voltage to the grid or a contract client off taker.

According to one example, flue gas from the HRSG 505 may be recirculated and metered into the rotary kiln 103 to limit peak particle temperature to achieve sintering without slagging the ash into the reformer to limit the peak temperature. According to one example, the peak temperature may be controlled such that a reducing atmosphere is sustained to minimize NOx formation in the reformer partial oxidation flame. According to one example, the gas temperature and residence time in the reformer may be sufficient to decompose PFAS and other forever chemicals. Furthermore, the peak temperature may be controlled to optimize an amount of remaining ammonia to serve as a non-selective catalytic reagent in the LoNOx burner 503 and into the quench to minimize the use of excess air to limit the influent temperature of the gases entering the superheater section of the boiler. In turn, this enables control of gas path composition and temperature.

Before exiting the rotary kiln gasification system, the flue gas may be cleaned by an air pollution control unit (APCU) 511 that removes most of the acid gasses and particulate before sending the cleaned flue gas to the carbon capture and utilization unit 104. According to one example, the flue gas from the HRSG 505 may be provided to an air pollution clean-up APCU/baghouse unit 511. According to one example, an exhaust gas stack 512 may be coupled to the APCU/baghouse unit 511. According to one example, the exhaust gas stack 512 may be coupled to a carbon capture and utilization unit 104.

According to one example, the APCU/baghouse unit 511 may include a sorbent injection system, an activated carbon injection system, an ammonia injection system, and a selective catalytic reactor, among other components. According to one example, these components all may be provided upstream of an economizer. According to one example, the APCU/baghouse unit 511 may include a second sorbent injection system, a second activated carbon injection system, and a second baghouse downstream of the economizer before entry into an induced draft blower (not shown), followed by discharge to the carbon capture and utilization unit (CC&U) unit 104. According to another example, the APCU/baghouse unit 511 may include a sorbent injection system and an activated carbon injection system, both downstream of the economizer and both upstream of a baghouse having a second sorbent injection system and an activated carbon injection system, followed by a selective catalytic reactor prior to entry into an induced draft blower followed by discharge to the CC&U unit 104.

With reference to FIG. 5, the rotary kiln gasifier 501 may be operated at a temperature of approximately 1,500° F. (+/−200° F.) in an oxygen starved environment to convert the feedstock to a hot producer gas that is cleaned in the reformer 502 where steam and/or air is introduced to promote staged combustions. According to one example, the temperature may be increased to above 1,800° F. to crack the tars, reform the light hydrocarbon gases, and thermally dissociate the PFAS.

According to one example, the cleaned hot producer gas is combusted in a LoNOx burner 503, after which the flue gas is quenched in the quench 504 to a temperature of approximately 1,400° F. to extend the service life of the superheater tubes in boiler of the HRSG 505. According to one example, high-pressure steam may be directed to the steam turbine 509 that drives an electrical generator 510. According to one example, lower pressure steam may be extracted from the steam turbine 509 and may be directed to the char steam treatment 108 and to sufficiently preheat the boiler feed water to avoid condensation of the flue gas stream exiting the economizer.

According to one example, electricity generated by the generator 510 via the steam turbine 509 may be sent to a transformer for house power 110 or to the substation 202, where the electrical power is stepped up to grid voltage as specified by the local grid operator or by a nearby off taker. According to one example, external power from the gasification power plant may be sold to a local utility or provided under contract to a local load such as a data center.

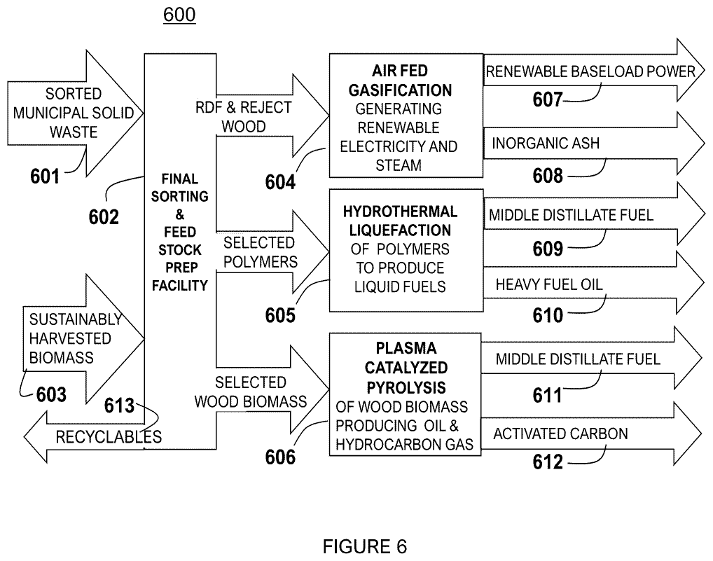

FIG. 6 illustrates an overall system that receives and directs sorted MSW and biomass through different systems to produce various products according to one example of the technology. According to one example, pre-sorted MSW 601 is conveyed to a final sorting and feedstock preparation facility 602, where the MSW 601 is shredded to a particle size of 200 mm or less. According to one example, any recyclables 613 that remain after the sorting may be separated from the RDF and sold. According to one example, an air fed gasification power plant 604 may receive RDF and reject wood to produce renewable electrical power 607 and an inorganic bottom ash 608. According to one example, a hydrothermal liquefaction unit 605 is provided to obtain selected polymers, including plastics, and clean sustainably harvested wood biomass 603 for conversion to renewable middle distillate fuels 609 and heavy fuel oil 610. According to one example, a plasma catalyzed pyrolysis unit 606 obtains selected wood biomass and performs plasma assisted pyrolysis to produce sustainable middle distillate fuels 611 and activated carbon 612. According to one example, the selected wood biomass may be dried and appropriately sized in the final sorting and feedstock preparation facility 602. This disclosure incorporates by reference U.S. Utility Pat. No. 11,649,403 entitled “Multi-Step Process for Conversion of Waste Plastics to Hydrocarbon Liquids,” which issued on May 16, 2023.

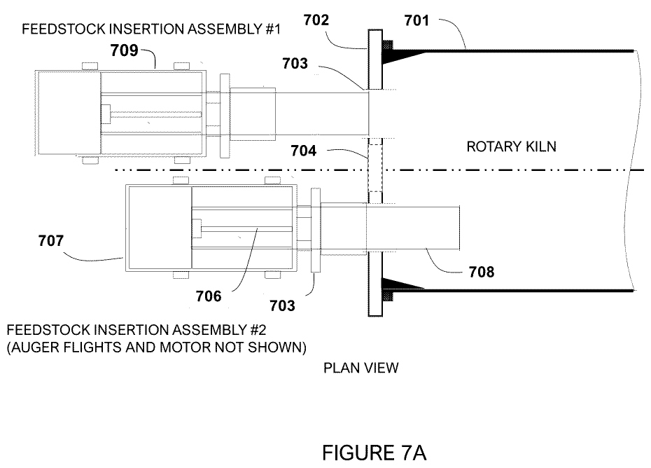

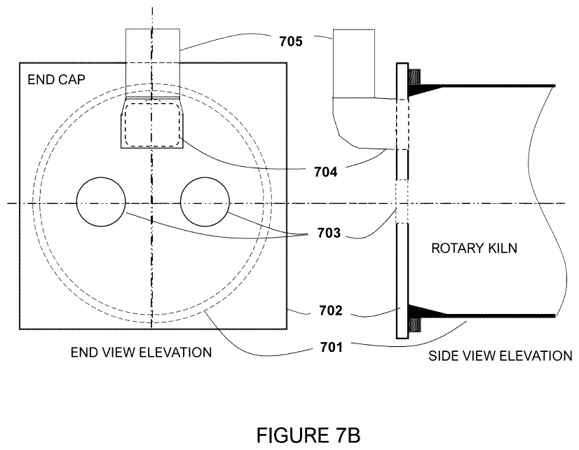

FIGS. 7A and 7B illustrate a multi-port rotary kiln 701 in a side elevation view, an end elevation view, and plan view according to one example of the technology. According to one example, the rotary kiln 701 includes an end cap 702 having two RDF feed ports 703a, 703b, a fuel gas extraction port 704, and a plenum 705. According to one example, the multi-port rotary kiln 701 illustrates removable auger driven RDF feed assemblies 707, 709 in plan view that are inserted into corresponding RDF feed ports 703a, 703b. According to one example, the removable auger driven RDF feed assemblies 707, 709 include a hopper, auger drive shaft motor, auger, and auger housing 708. FIG. 7A illustrates the RDF feed assembly 709 withdrawn from the kiln end cap 702 and the RDF feed assembly 707 partially inserted into the kiln end cap 702. According to one example, the auger drive shaft 706 of the feed assembly is powered by an electric motor (not shown). According to one example, the RDF is loaded into a hopper of the RDF feed assembly 709 and inserted into the rotary kiln 701 by an auger via the drive shaft 706. According to one example, the multi-port rotary kiln 701 is designed to (1) increase the reliability of RDF feed into the rotary kiln 701 and (2) allow steady state or intermittent feeding of two types of RDF including, for example, wood biomass and dried wastewater sludge.

According to one example, failure of the feedstock insertion system is a leading reason for unscheduled downtime of thermal waste to energy systems. The present technology addresses this issue by building redundancy into the RDF feed system by employing two separate feedstock auger systems for insertion of RDF into the rotary kiln 701. According to one example, each rotary kiln end cap 702 is fitted with two insertion ports 703a,703b, each with a corresponding feedstock insertion assembly 707,709. This design both increases feedstock insertion reliability and allows simultaneous use of two separate feedstock insertion assemblies 707,709.

According to one example, the feedstock insertion system provides an advantage that feedstocks of differing calorific value may be metered into the rotary kiln gasifier 701 such that the thermal output of the rotary kiln gasifier 701 may be maintained within a specified range. According to one example, feedstock combinations that can be utilized in this manner include (1) RDF and wood biomass; (2) RDF and waste plastic; (3) dried bio sludge and RDF; and so forth. According to one example, one port may be used for RDF insertion, while a second port may be used for feeding biomass feedstock in the form of wood chips. According to one example, the feedstock insertion assemblies may be removed from the rotary kiln 701 for adjustment or maintenance while in operation.

According to one example, a ratio of MSW to wood biomass feedstock provided to the rotary kiln gasification power plant 103 is determined by whether the primary application is for (1) safe and economical final disposal of MSW or (2) for the management of unwanted biomass growth in rangeland or forests. When the interdependent facility 100 is employed primarily to manage MSW, the primary revenue streams are MSW gate fees and revenue from electrical power sales. Furthermore, converting woody biomass from local agriculture or forestry sources using pyrolysis or HTL for primary processing before refining adds sustainable fuel and/or specialty chemicals and activated carbon to the revenue stream.

In contrast, if a primary application is management of unwanted biomass growth on rangeland or in forests, the rotary kiln gasification power plant 103 can be scaled to operate at a level that provides house power for the CC&U unit 104, the biomass conversion, and the activated carbon production systems. According to one example, any MSW and locally sourced biomass that is unsuitable for fuel production may be used as gasification feedstock to generate power. In this case, the power generated only needs to be sufficient for facility operation.

A first example of the technology is an environmentally beneficial alternative to open burning of wood biomass obtained from the thinning of native trees on land, including federal and privately owned land. Wildfires are increasing in frequency and severity mainly due to climate change, which leads to accelerated growth of biomass on forests and sage lands in the southwest. Accelerated growth is caused by adequate rainfall, followed by an extended drought which increases fire risk. A conventional approach to reducing forest biomass is to thin the trees such as juniper and pinion pine, assemble the slash into piles, and burn these piles in the open. However, open burning is environmentally harmful and no longer an acceptable option for disposing of such waste biomass. Still further, using biomass as fuel for directly fired boilers in steam power plants is not economically viable due mainly to the cost of harvesting and transporting the relatively low calorific value biomass to conventional thermal power plants.

An alternative viable approach enabled by the present technology includes converting the harvested biomass as a monofuel feedstock to fully sustainable hydrocarbon or oxygenated hydrocarbon liquid fuels in facilities built in or near the source of the biomass. The approach enabled by the present technology includes building a gasification power plant operated on MSW. In this case, the gate fees are a significant source of revenue. Such facilities may be located in relatively remote areas on existing railroad lines, where they include onsite production of the electrical power required for operation. Railroad transport allows MSW to be brought in from centers of higher population and allows for the products of the facility, including fully sustainable hydrocarbon fuels and activated carbon, to be economically transported to lucrative markets.

A second example of the technology includes the environmentally responsible and economically attractive utilization of woody biomass stranded in managed forest due to a decline in the pulp and paper industry. Deployment of broadly scalable biomass to fuels technology can create a market for forestry biomass resources that are stranded by the recent closure of paper and fiberboard mills. The technology will help to reinvigorate local forestry-dependent economies that are adversely impacted by the recent shutdown of pulp and paper mills in southeastern US forests. This is a primary goal of the biomass-to-sustainable fuels projects described in this disclosure.

According to one example, economical replacement of fossil fuels with biomass derived fuels requires that the conversion technology be located near the renewable biomass resource to reduce logistics costs. While this shift in conversion of forestry resources will benefit the environment by reducing reliance on fossil fuels, a primary benefit will be to the local communities, where many workers have lost employment with the shutdown of local pulp and paper mills.

A third example of the technology includes converting higher calorific value feedstocks such as those with increased waste plastic content. There is a relatively greater hydrogen to carbon ratio, and an absence of heteroatoms other than oxygen in the molecular structure of commonly used plastics such as polyethylene (PE), polypropylene (PP) and polyethylene terephthalate (PET). This makes common plastics good feedstocks for co-processing with wood biomass to produce low carbon intensity renewable fuels. According to one example, adding these plastics to wood biomass feedstock can increase the hydrocarbon fuel yield of the pyrolysis unit and increase the financial return from processing MSW. If sufficient plastic is available, processing plastic as a monofuel by HTL is an economically attractive alternative. Processing plastic content to make liquid hydrocarbon fuels can justify the cost of the equipment needed to remove suitable plastics from the MSW and increase the value of MSW feedstocks to the operation.

The technology described herein offers many advantages. For example, when used to reduce the net economic cost and emissions of GHGe and criteria pollutant emissions associated with trimming and disposal of unwanted tree growth, the present technology: (1) reduces the net cost of tree thinning by converting the wood biomass to sustainable liquid fuels, rather than being disposed by open burning; (2) reduces GHGe and criteria pollutant emissions from open burning of waste tree wood and slash; (3) reduces use of fossil fuels for transportation and industry by providing fully sustainable biofuels for air, sea, and land transportation; (4) provides an environmentally responsible option for reducing MSW mass by approximately 90% with the remainder going to remote inorganic landfills that will not emit GHGe HAP, or PFAS. The gasification power plants provide a bottom ash that includes sintered aggregates that could have beneficial uses; and (5) meets or exceeds existing best available control technology (BACT) requirements for control of air pollutant emissions under Federal and State laws.

When applied to stranded biomass resources in formerly managed forests, advantages of the invention include: (1) produces clean, renewable, cellulosic fuels from sustainably cultivated biomass, with attractive investment returns; (2) eliminates fossil carbon emissions from hydrocarbon fuels use; (3) supports a sustainable industry that provides agricultural and high-tech jobs; (4) helps revitalize regions where pyrolysis mills have been closed and have stranded regional forestry resources; (5) provides expansion potential through feedstock cultivation in regions that support rapid growth rate tree species; and (6) helps to restore and sustain spent agricultural and forested land.

The present technology provides the following advantages: (1) safe, effective, environmentally friendly and economically attractive final disposal of municipal solid waste for urban centers currently running out of landfill airspace or where landfilling of MSW is no longer permitted; (2) clean, ultra-low emission gasification of MSW as a source of renewable electrical power, the use of which increases the value of sustainable hydrocarbon and oxygenated hydrocarbon fuels, and/or the resulting specialty chemicals; (3) ability to position a facility in or near the forest source of the biomass to reduce transport costs for the woody biomass feedstock and for exported products, especially by rail, the facility supporting self-generated electrical power; (4) employing carbon capture and utilization technology to significantly reduce the emission of CO₂, especially fossil carbon CO₂ that would otherwise be needed to generate the power to operate the plant; and (5) offering off the grid “Black Start” capability as a self-sufficient plant that can be installed in remote rangeland or forest areas, generating its own electricity for in-house use and hydrocarbon fuel for startup without the benefit of gird power.

From the foregoing it will be appreciated that, although specific examples are described herein for purposes of illustration, various modifications may be made without deviating from the spirit and scope of this disclosure. For example, the methods, techniques, and systems for thermally converting sorted MSW and biomass to produce electrical power, along with liquid and gas phase hydrocarbons, are applicable to other settings.

While the preferred example of the technology is illustrated and described, as noted above, many changes can be made without departing from the spirit and scope of the invention. Accordingly, the scope of the invention is not limited by the disclosure of the preferred example.

What is claimed is:

1. A method of thermally converting sorted municipal solid waste and biomass to produce electrical power, along with liquid and gas phase hydrocarbons, the method comprising:
sorting municipal solid waste to reject non-combustible and hazardous waste to obtain a refuse derived fuel employed as a gasification feedstock;
generating thermal energy, steam, and renewable electrical power by gasifying the gasification feedstock, including a wood biomass; and
creating renewable or sustainable gas and liquid phase fuels by employing said renewable electric power to convert the wood biomass obtained from forests, the refuse derived fuel, or plastics separated from the refuse derived fuel.

2. The method of claim 1, further comprising shredding the municipal solid waste to form the refuse derived fuel having a particle size of 200 mm or less, wherein the municipal solid waste is sorted to remove hazardous and inert materials.

3. The method according to claim 1, further comprising introducing the gasification feedstock, including the wood biomass, into a counter current rotary kiln having axial kiln air injection.

4. The method according to claim 3, wherein the gasification feedstock and the wood biomass are introduced into multiple feedstock insertion ports in one endcap of the counter current rotary kiln.

5. The method according to claim 1, further comprising reforming and combusting a fuel gas in a LoNOx burner at a temperature and at a residence time sufficient to thermally disassociate fluoroalkanes and produce steam in a boiler.

6. The method according to claim 1, wherein the renewable electrical power is generated by a steam turbine used to fulfill electrical power needs of a facility.

7. The method according to claim 1, further comprising:
grinding the wood biomass used as gasification feedstock for the pyrolysis unit to a particle size and density below that of a Geldart Class D powder; and
drying the wood biomass before being processed by a plasma assisted pyrolysis unit.

8. The method according to claim 7, further comprising processing sustainably harvested forestry products as feedstock in the pyrolysis unit.

9. The method according to claim 1, further comprising employing hydrothermal liquefaction to convert the plastics and the wood biomass feedstocks to renewable liquid fuels.

10. The method according to claim 1, further comprising converting char residue from pyrolysis of wood to activated carbon using steam from gasifying gasification feedstock.

11. The method according to claim 1, further comprising:
capturing carbon dioxide from exhaust gas of a gasification power plant, and
converting the carbon dioxide to gas phase or liquid phase hydrocarbon fuels.

12. The method according to claim 11, wherein the carbon dioxide from the power plant exhaust gas is captured by dissolution in an amine solution.

13. The method according to claim 11, wherein the carbon dioxide obtained from the gasification power plant exhaust is used as a feedstock for catalytic conversion to hydrocarbons or oxygenated hydrocarbon fuels.

14. The method according to claim 13, wherein the catalytic product is further refined though distillation and filtration to produce liquid fuel, including oxygenated fuels and specialty chemicals such as methanol, ethanol, dimethyl ether, or higher alkyl ethers.

15. The method according to claim 1, wherein a portion of the refuse derived fuel includes liquified petroleum gases.

16. The method according to claim 10, wherein the pyrolysis of wood does not feature plasma assistance in providing the endothermic heat required for efficient energy balance and optimal product yield distribution.

17. The method according to claim 5, wherein the fuel gas is reformed to provide hydrogen for optimally achieving overall plant material and energy balance.

18. The method according to claim 1, further comprising producing oxygen and hydrogen using electrolysis performed by a water management system.

19. The method according to claim 18, wherein producing the oxygen is used to optimize operability and performance of the refuse derived fuel gasification portion of the process.

20. The method according to claim 11, further comprising employing ultrasonic cavitation to provide local temperatures and pressures associated with collapsing bubbles to convert dissolved carbon dioxide in an aqueous amine solution to carbon monoxide and methane.
